(19) United States
(12) Patent Application Publication
(10) Pub. No.: US 2007/0103385 A1
(43) Pub. Date: May 10, 2007

(54) DISPLAY APPARATUS AND METHOD USED IN A HAND-HELD DEVICE

(75) Inventors: Wen-Chuan Lian, Shenzhen (CN); Han-Che Wang, Shenzhen (CN); Kuan-Hong Hsieh, Shenzhen (CN); Chun-Wei Pan, Shenzhen (CN); Hua-Dong Cheng, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,507

(22) Filed: Aug. 15, 2006

(30) Foreign Application Priority Data
Nov. 10, 2005 (CN) 200510101254.3

(51) Int. Cl. G09G 5/00

(52) U.S. Cl. 345/1.1

(57) ABSTRACT

A display apparatus used in a hand-held device is provided. The display apparatus includes a first display, a second display, a plurality of input devices, and a processing unit. The first display is a non-volatile display, and the second display is a volatile display. The input devices are for operational inputs. The processing unit displays edited information on the second display in response to the operational inputs from the input devices for editing inputs, and updates the first display with the edited information in response to the operational input from the input device for conformation inputs. A related method is also provided.

### TECHNICAL FIELD

The present invention relates to display apparatuses and methods therefor, and particularly to a display apparatus and method used in a hand-held device such as an electronic book reading device.

### GENERAL BACKGROUND

With the fast development in electronic technologies, a large number of hand-held electronic devices have been introduced in the electronics consumer market, products such as mobile phone, personal digital assistant (PDA), electronic book reading device, readily satisfying a business requirement or an amusement requirement. These available hand-held devices are not only for displaying visual messages that include graphics and text data as well as a means to access and manipulate such messages, but also for editing visual messages. Therefore, in order to display or edit these visual messages, each hand-held device provides one or more displays therein.

Accordingly, the hand-held device can display information, such as time, date, power consumption, schedule, incoming-calls, messages, etc., through the display(s). However, the hand-held device has a high power consumption when using a volatile display for information display. That is, the hand-held device has to maintain power to the display power in order to display the information.

Therefore, in order to solve the largely power consumption, some hand-held devices (e.g., electronic book reading devices) use a non-volatile display instead for information display. Accordingly, the hand-held devices can display the information without power consumption. However, these hand-held devices have slow response speed due to that the non-volatile display has a relatively lower response speed compared to the volatile display. As a result, when displaying information anew, these hand-held devices need relatively more time to display new input information on the displays thereof.

What is needed, therefore, is a display apparatus and method employed in a hand-held device, which not only has a relatively higher response speed, but also can reduce power consumption.

### SUMMARY

A display apparatus used in a hand-held device is provided. The display apparatus includes a first display, a second display, a plurality of input devices, and a processing unit. The first display is preferably a non-volatile display, whereas the second display is preferably a volatile display. The input devices are for operational inputs. The processing unit is programmed for controlling the first display and the second display in response to the operational inputs from the input devices.

A display method used in a hand-held device is also provided. The hand-held device has a first display being a non-volatile display, a second display being a volatile display, and a plurality of input devices. The method includes the steps of: (a) displaying real-time information of the hand-held device on the second display; (b) displaying edited information on the second display, in response to operational inputs from the input devices for editing inputs; and (c) updating the edited information on the first display, in response to an operational input from the input device for conformation inputs.

Other advantages and novel features will be drawn from the following detailed description with reference to the attached drawing, in which:

### BRIEF DESCRIPTION OF DRAWINGS

FIG. 1 is a schematic diagram of a hardware infrastructure of a display apparatus used in a hand-held device in accordance with a preferred embodiment of the present invention; and

FIG. 2 is a flowchart of a preferred display method used in a hand-held device by utilizing the display apparatus of FIG. 1.

### DETAILED DESCRIPTION

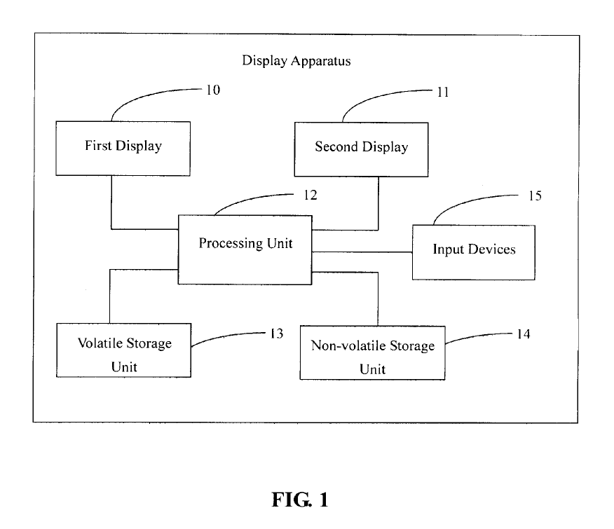

FIG. 1 is a schematic diagram of a hardware infrastructure of a display apparatus in accordance with a preferred embodiment of the present invention. The display apparatus can be incorporated into a hand-held device such as, for example, electronic book reading device, personal digital assistant, etc, for displaying information of the hand-held device. The display apparatus has a first display 10, a second display 11, a processing unit 12, and a plurality of input devices 15.

The first display 10 is preferably a non-volatile display such as an Electronic Ink (E-Ink) display, whereas the second display 11 is preferably a volatile display such as a Thin Film Transistor Liquid Crystal Display (TFT LCD). The first display 10 is capable of displaying information after being powered off. In addition, the first display 10 is relatively larger than the second display in size. The second display 11 displays real-time information of the hand-held device. The real-time information may include, for example, such as a system time, a chapter of information displayed on the first display 10, a page number of information displayed on the first display 10, and the like.

The input devices 15 are for generating operational input signals to perform related functions such as, for example editing information (e.g., inputting information), confirmation inputs, and so on. The input devices 15 further include a first input device for editing inputs and a second input device for confirmation inputs.

The processing unit 12 is programmed to control the first display 10 and the second display 11 in response to the operational input signals from the input devices 15. For example, in response to the operational input signals corresponding the first input device, the processing unit 12 signals the second display 11 to display edited information corresponding the editing inputs on the first input device; in response to the operational input signals corresponding confirmation inputs on the second input device, the processing unit 12 updates the first display 10 with the edited information thereon, and further signals the second display 11 to redisplay the real-time information of the hand-held device. Furthermore, the processing unit 12 also signals to powers off the first display 10 after updating the edited information thereon, thereby reducing power consumption of the hand-held device.

In addition, the processing unit 12 executes other operations on the second display 11 in response to operational signals from other input devices 15 exclusive of the first and second input devices. Moreover, while executing other operations exclusive of the first display 10, the processing unit 12 can also maintain a power off state on the first display 10.

Therefore, by utilizing the display apparatus, the hand-held device can display information on the first display 10 with no power consumption thereon until required updating the information on the first display 10, and can simultaneously execute any operations on the second display 11. Furthermore, the first display 10 is in a larger size and having a relatively lower response speed, and the second display is in a smaller size and having a relatively higher response speed, therefore, not only can the hand-held device enhance a response speed, but can also reduce power consumption thereof.

The display apparatus further includes a volatile storage unit 13 and a non-volatile storage unit. The volatile storage unit 13 may be a Random Access Memory (RAM) for storing information required or generated during the operation inputs on the hand-held device. The non-volatile storage unit 14 may be a Read-Only Memory (ROM) or a Flash memory.

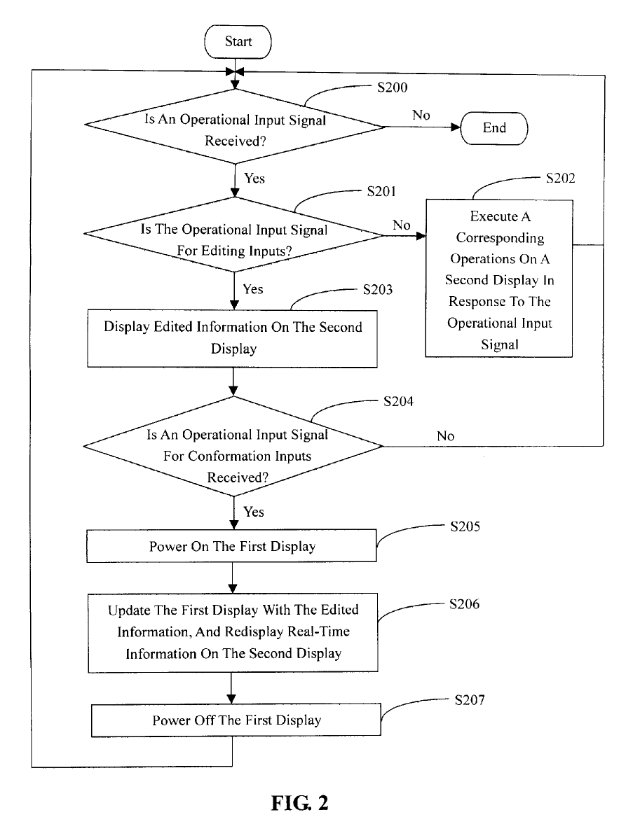

FIG. 2 is a flowchart of a preferred display method used in a hand-held device by utilizing the display apparatus of FIG. 1. In step S200, the processing unit 12 determines whether it receives an operational input signal from the input device 15. If not, the procedure is finished. If so, in step S201, the processing unit 12 determines whether the operational input signal corresponds to editing inputs, that is, whether the operational input signal is from the first input device.

If the operational input signal is not from the first input device, in step S202, the processing unit 12 executes corresponding operations on the second display 11 corresponding to the operational input signal.

If the operational input signal is from the first input device, in step S203, the processing unit 12 signals to display the edited information corresponding the editing inputs on the first input device on the second display 11.

In step S204, the processing unit 12 determines whether it further receives an operational input signal corresponds to confirmation inputs, that is, whether the operational input signal is from the second input device. If not, the procedure goes to step S200 described above. If so, in step S205, the processing unit 12 signals to power on the first display 10.

In step S206, the processing unit 12 updates the first display 10 with the edited information thereon, and redisplays real-time information of the hand-held device on the second display 11.

In step S207, the processing unit signals to power off the first display 10 after updating the edited information thereon.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A display apparatus used in a hand-held device, the display apparatus comprising:
a first display which is a non-volatile display;
a second display which is a volatile display;
a plurality of input devices for operational inputs; and
a processing unit being programmed for controlling the first display and the second display in response to the operational inputs from the input devices.

2. The display apparatus according to claim 1, wherein the second display is in a size smaller than that of the first display, and is for displaying real-time information of the hand-held device.

3. The display apparatus according to claim 2, wherein the processing unit displays edited information on the second display in response to the operational inputs from the input devices for editing inputs.

4. The display apparatus according to claim 3, wherein the processing unit retains the first display in a power off state when displaying the edited information on the second display.

5. The display apparatus according to claim 3, wherein the processing unit updates the first display to display the edited information in response to the operational input from the input device for conformation inputs.

6. The display apparatus according to claim 5, wherein the processing unit further redisplays the real-time information of the hand-held device on the second display in response to the operational input from the input device for conformation inputs.

7. The display apparatus according to claim 5, wherein the processing unit further powers off the first display after updating the edited information thereon.

8. A display method used in a hand-held device, wherein the hand-held device has a first display, a second display, and a plurality of input devices, the first display being a non-volatile display and the second display being a volatile display, the display method comprising the steps of:
displaying real-time information of the hand-held device on the second display;
displaying edited information on the second display in response to operational inputs from the input devices for editing inputs; and
updating the edited information on the first display in response to an operational input from the input device for conformation inputs.

9. The display method according to claim 8, wherein the displaying edited information step further comprises the step of: retaining the first display in a power off state.

10. The display method according to claim 8, further comprising the steps of:
redisplaying the real-time information of the hand-held device on the second display in response to the operational input from the input device for conformation inputs; and
powering off the first display after updating the edited information thereon.
